(19) United States
(12) Patent Application Publication
(10) Pub. No.: US 2026/0214102 A1
(43) Pub. Date: Jul. 23, 2026

(54) System and Method for the Orchestration of Diverse Media Fraud Detection in Web Content using a Network of Machine Learning Agents

(71) Applicant: MICHAEL J BORDASH, Newtown, CT (US)

(72) Inventor: MICHAEL J BORDASH, Newtown, CT (US)

(21) Appl. No.: 19/031,491

(22) Filed: Jan. 18, 2025

(51) Int. Cl. H04L 9/40

(52) U.S. Cl. CPC H04L 63/1416

(57) ABSTRACT

Disclosed aspects include orchestration of machine learning and/or other rule-based indicators across elements of a webpage, including text, images, URLs, phone numbers, audio, video, to determine overall fraudulent intent. A set of dynamic web site data is received via a web browser extension installed and opted-in by the end user. The orchestration technique may be used to process the set of dynamic web site data. Accordingly, a fraud event is detected using the orchestration technique. Based on a selection criterion with respect to the fraud event, it is determined to provide an opportunity to warn the end. In response to making the determination, the opportunity can be provided to produce an alert injected into the visited website by the end user.

### BACKGROUND OF THE INVENTION

The proliferation of online fraud has necessitated the development of tools to detect and warn users about potentially fraudulent content. In addition to typical phishing and imposter-brand websites, criminals are embedding fraudulent methods in legitimate websites to trick users into trusting the content presented. These criminals use content that resembles professional marketing presentation including text, images, phone numbers, audio, and video. Current solutions often lack specificity in the orchestration of fraud detection among a variety of content employed by criminals, leading to either inadequate coverage or false positives, or the solutions simply try to match a visited website with a database of URLs that were reported as fraudulent in recent past. These methods allow a window of opportunity between when a fraudulent website is detected by a human or machine analyst and when this detection can be used to warn users that the site they are visiting might contain fraudulent content. This invention introduces an orchestration method embedded as a web browser extension, for targeted fraud detection using a network of machine learning agents that explore each element of a web page (text, images, phone numbers, URLs, audio, video) to determine fraudulent intent on the current web site a user is visiting, enhancing user safety with minimal disruption and privacy invasion.

### SUMMARY OF THE INVENTION

This invention discloses a method implemented as a web browser extension (such as Chrome, Safari, FireFox and others on Desktop or Mobile devices) for the detection of fraudulent content on the current website visited by the end user. All communication is performed over encrypted channels and behavioral logging is not introduced in order to preserve privacy for the end user. The system includes:
a. Domain Specification Mechanism: A component within the extension's configuration that allows the user or developer to define which domains are to be monitored for fraudulent activities. This may include all websites visited or a list of sites to be monitored and scanned.
b. Content Extraction Module: Upon accessing a page within the visited domain, this module extracts all content from the HTML of the webpage, including text, images, phone numbers, crypto wallet numbers, additional URLs, embedded content from external websites, audio and video files.
c. Fraud Detection Algorithms: Utilizes a set of predefined indicators or machine learning models to identify patterns associated with fraudulent schemes within the extracted content. This includes models trained to detect fraud for each of the content media types extracted by the web browser extension.
d. Fraud Result Determination Algorithm: Collects the result of each of the Fraud Detection Algorithms and makes an overall determination whether the page the user is visiting contains fraudulent content.
e. Notification System: If fraudulent content is detected, the system triggers a user notification via a browser popup or an in-page alert, warning the user about potential risks.
f. Notification Preservation: If an alert is determined to be required, the system will periodically monitor the website to make sure the alert is not overwritten by the website application itself or via some fraudulent means to prevent display of such alerts. If the alert is found to be missing, the system will redisplay the alert.
g. User Interface for Interaction: A minimalistic interface in the browser's popup or a dedicated page where users can view detected fraud alerts, adjust settings, deactivate the extension, and test content found within other viewing medium such as text message content, local documents, and audio/video calls made outside the context of the web browser extension.

### BRIEF DESCRIPTION OF DRAWINGS

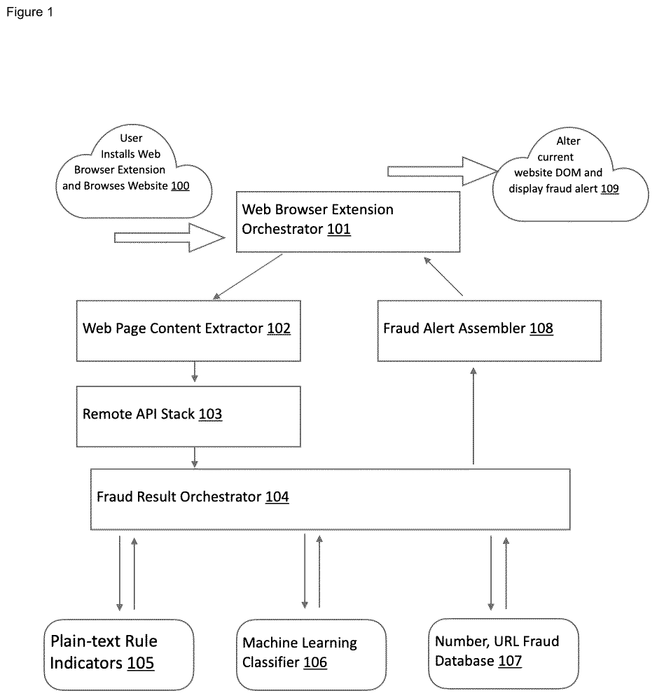

Now turning to the figure, FIG. 1 depicts a high level block diagram representing the flow. A user opts-in to install the web browser extension, configures domain settings, and browses a website 100. The web browser extension 101 begins to orchestrate the determination of fraud by first checking whether the current website is configured for scanning by the end user, if so, extracting 102 the current website DOM (Document Object Model) and parsing each media type in preparation for sending to an API. The Remote API Stack 103 receives the media package and then passes the content to the fraud result orchestrator 104. Each content type is sent to the respective service that will determine whether fraud might be present and then return an overall prediction with confidence level 105 106 107. These results are returned back to the fraud result orchestrator 104 which makes the final determination whether part or all of the web site contains fraudulent content. This final determination is sent to the fraud result assembler 109 which will either take no action if no/low-confidence fraud is present or prepare an alert. If it is determined that an alert should be displayed, it is sent back to the Web Browser Extension Orchestrator 101 which will then alter the current webpage 109 by inserting the alert in the DOM. The Web Browser Extension Orchestrator 101 will monitor the webpage to make sure the alert doesn't get overwritten and will re-display the alert if found to be missing.

### DETAILED DESCRIPTION OF THE INVENTION

Manifest and Initialization: The extension is defined in a manifest file, which includes permissions for active tab monitoring, matches for specific domains if configured by the end user or the developer, and permission granted by the end user to allow fraud detection. Upon installation, the extension initializes by loading its rule sets for fraud detection.

Content Script Operation: When a user navigates to a page within a monitored domain, the content script:
a. Checks if the current domain is in the list to be monitored
b. If yes, or if all domains are permitted to be scanned, it scans the page's content and submits each content type to the respective machine learning API for fraud determination
c. Fraud Detection:
   i. The detection might involve simple keyword matching or more complex analysis like fraudulent intent detection, perceptual and standard image hashing comparison, deepfake content analysis, audio analysis, fraudulent phone number lookup, fraudulent url lookup, and other anomaly detection algorithms that may be appropriate to the content scanned by the web browser extension
   ii. Upon detection, a message is sent to the background script or directly to the popup to alert the user.
   iii. Should the website employ methods to re-write the DOM whether through legitimate or illegitimate methods, the script will re-introduce the fraud alert to ensure the end user sees the determination
d. User Feedback and Control:
   i. The user can interact with the popup to acknowledge alerts, view detailed information about the detected fraud, or adjust settings like sensitivity or domain list for scanning

1. A method for detecting fraudulent content on visited web domains, comprising:
a. Identifying a domain from a pre-configured list of, or all, domains to monitor;
b. Orchestrating the extracting all content types from web pages within identified domains;
c. Orchestrating the analysis of the extracted content for patterns indicative of fraud using a predefined set of fraud indicators and machine learning services;
d. Notifying users through a browser interface upon detection of fraudulent content;
e. Checking whether the alert was removed by legitimate or illegitimate means and then re-introducing the alert for observation by the end user.

2. The method of claim 1, further comprising:
a. A user interface for configuring the list of domains and sensitivity of fraud detection.

3. An apparatus for implementing the method of claim 1, comprising:
a. A browser extension configured to operate within web browsers to execute the steps of claim 1.

4. The apparatus of claim 3, wherein:
a. The fraud detection includes machine learning models trained to recognize new patterns of fraudulent text.
